(19) United States
(12) Patent Application Publication
(10) Pub. No.: US 2009/0066713 A1
(43) Pub. Date: Mar. 12, 2009

(54) Medical Image System

(75) Inventor: Takanori Ando, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Medical & Graphic, Inc., Tokyo (JP)

(21) Appl. No.: 12/224,102

(22) PCT Filed: Feb. 20, 2007
(86) PCT No.: PCT/JP2007/053073

§ 371 Date: Aug. 18, 2008

(30) Foreign Application Priority Data
Feb. 28, 2006 (JP) 2006-052398

(51) Int. Cl. G09G 5/00

(52) U.S. Cl. 345/581

(57) ABSTRACT

A medical image system capable of changing a display configuration to a desired one by an easy operation is provided. In a medical image system 1 including medical image display apparatuses 5A and 5B, each equipped with one or a plurality of monitors, a server 3 stores display configuration files of object data according to monitor configurations adoptable in the aforesaid medical image display apparatuses, and transmits the display configuration file corresponding to the monitor configuration of the medical image display apparatus 5A or 5B that displays the object data among the stored display configurations to the medical image display apparatus 5A or 5B. The medical image display apparatus 5A or 5B displays the object data on the monitors on the basis of the transmitted display configuration files, and changes the present display configuration to the display configuration corresponding to another monitor configuration according to an instruction operation by a user to redisplay the object data.

### TECHNICAL FIELD

The present invention relates to a medical image system to display medical image data and display object data pertaining to other medical images on a monitor.

### BACKGROUND ART

In recent years, the conversion of medical image in a hospital into electronic data has advanced, and a medical image system to assume a series of processing from the radiographing of a medical image to the display of the medical image has been built. The medical image system saves the data of medical images obtained by a radiographing apparatus and the like in a large-capacity memory, and a server manages the data to distribute the data to a medical image display apparatus placed at each places such as a consultation room in a hospital and the like.

At the time of radiogram interpretation of a medical image, a doctor sometimes observes a plurality of medical images arranged side by side, or displays a patient list screen, a report creation screen, or the like, in parallel together with the medical image. Accordingly, many medical image display apparatuses are severally provided with a plurality of monitors instead of only one monitor.

Because it is troublesome to set what type of display content is displayed on which monitor at every use of a medical image display apparatus, it has been performed conventionally that a display configuration is determined for each doctor and the determined display configuration is registered in a server in advance, and that the display configuration corresponding to a doctor who has logged in a medical image display apparatus is obtained from the server at the time of the login to perform a display based on the obtained display configuration (see, for example, Patent Document 1).

### [Patent Document 1] Japanese Patent Application Laid-Open Publication No. 11-282936

### DISCLOSURE OF THE INVENTION

### Problem to be Solved by the Invention

However, even when the same display apparatus is being used, the display configuration is wanted to be changed sometimes. For example, there is a case where a doctor has adopted a display configuration of displaying a patient list, a medical image, and a report on three monitors, respectively, and then the doctor wants to use one of the monitors being used as an electronic chart and to display a screen of the electronic chart on the monitor displaying the patient list. In this case, the doctor must perform operations while sequentially changing a creation screen of the electric chart and a display screen of the patient list in order to display the display screen of the patient list and the creation screen of the electronic chart in a superposition state. Thus, the operations have been very troublesome.

In the case mentioned above, it is preferable to be able to change the display configuration in a way of displaying the electronic chart and the medical image by using only two monitors among the three monitors, for example.

However, because the conventional medical image system defines one display configuration for each doctor on the supposition that a doctor fixedly uses a certain medical image display apparatus, a doctor must change display content by manual operations of individual monitors in order to change a display configuration to a different one after the login to the medical image display apparatus.

It is an object of the present invention to provide a medical image system capable of changing a display configuration to a desired one by easy operations.

### Means for Solving the Problem

According to the invention as claimed in claim 1, a medical image system comprises:

a medical image display apparatus comprising one or a plurality of monitors;

a storage section to store display configurations of object data, which correspond to each of monitor configurations adoptable in the medical image display apparatus;

a display control section to display the object data on a monitor of the medical image display apparatus based on a display configuration corresponding to any one monitor configuration among the stored display configurations; and

a switching control section to switch the display configuration corresponding to the one monitor configuration to a display configuration corresponding to another monitor configuration.

### EFFECT OF THE INVENTION

According to the invention as claimed in claim 1, it becomes possible to freely change a display configuration to be displayed to the one corresponding to a different monitor configuration. Consequently, it is possible to easily change a display configuration to an arbitrary one according to a use after the login to a medical image display apparatus, and the medical image display apparatus has high convenience.

According to the invention as claimed in claim 2, it becomes possible to easily identify the presently adopted display configuration on the basis of identification information.

According to the invention as claimed in claim 3, a user can specify the display configuration to be changed, and can freely change the display configuration to the one corresponding to another monitor configuration.

According to the invention as claimed in claim 4, it is possible not only to adjust a display configuration to a desired monitor configuration, but also to display object data in a display configuration in accordance with the display content or the like that a user wants. Thereby, it becomes possible to customize display content and the like, and thus the convenience is improved.

According to the invention as claimed in claim 5, it is possible to easily grasp the display configuration that is presently used for the display of object data on the basis of identification information.

According to the invention as claimed in claim 6, it is possible to specify a desired display configuration among a list, and to easily change a display configuration.

### BRIEF DESCRIPTION OF THE DRAWINGS

FIG. 1 This is a diagram showing the configuration of a medical image system of the present embodiment.

FIG. 2 This is a diagram showing the configuration of a server shown in FIG. 1.

FIG. 3 This is a diagram showing an example of a registered user file stored in a storage section shown in FIG. 2.

FIG. 4 This is a diagram showing an example of a display configuration table stored in the storage section shown in FIG. 2.

FIG. 5 This is a diagram showing an example of a monitor file stored in the storage section shown in FIG. 2.

FIG. 6 This is a diagram showing the configuration of a medical image display apparatus shown in FIG. 1.

FIG. 7 This is a flowchart showing the display configuration file supplying processing executed by the server.

FIG. 8 This is a flowchart showing object data displaying processing executed by the medical image display apparatus.

FIG. 9 This is a view showing a display example of object data.

FIG. 10 These are views showing an example of an operation menu for specifying another display configuration.

FIG. 11 This is a view showing a display example of object data when a display configuration is changed to another one.

### EXPLANATION OF REFERENCE NUMERALS

1 medical image system
3 server
31 control section
34 storage section
341 registered user file
342 display configuration table
343 monitor file
4 NAS
5A, 5B medical image display apparatus
51 control section
53a, 53b, 53c monitor

### BEST MODE FOR CARRYING OUT THE INVENTION

First, a configuration is described.

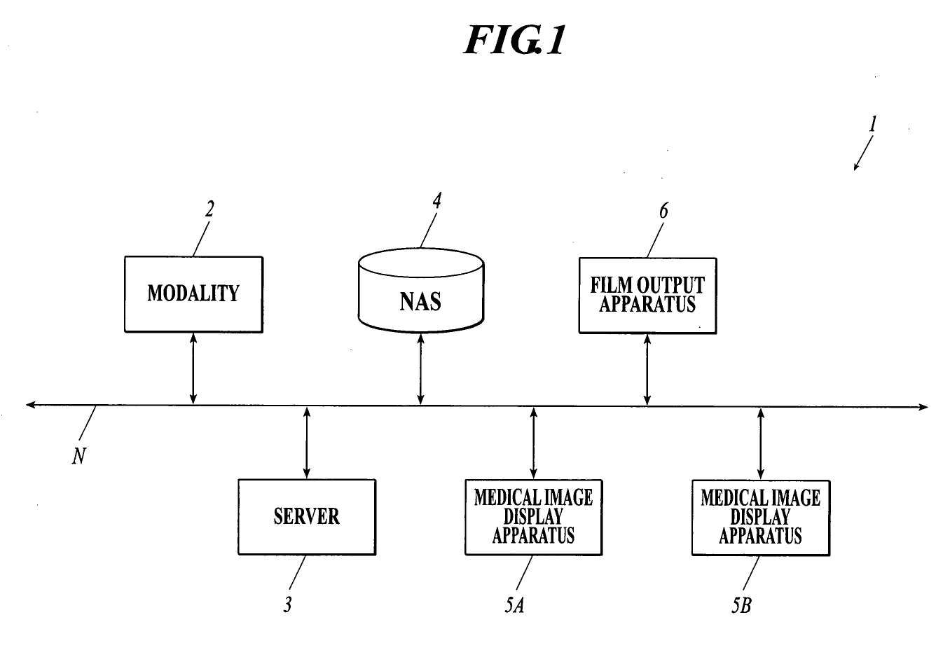

FIG. 1 shows the system configuration of a medical image system 1 of the present embodiment.

The medical image system 1 is composed of a modality 2, a server 3, a network attached storage (NAS) 4, medical image display apparatuses 5A and 5B, and a film output apparatus 6, as shown in FIG. 1. Each configurational apparatus is connected to one another through a network N. The network N is a local area network (LAN) in conformity with the Digital Imaging and Communication in Medicine (DICOM) standard.

The medical image system 1 saves data, such as a report, besides a medical image radiographed by the modality 2, in the NAS 4, and manages the input and the output of the data and the medical image by the server 3. By the control of the server 3, each piece of data saved in the NAS 4 is output to the film output apparatus 6 or the medical image display apparatuses 5A and 5B.

In the following, each configurational apparatus is described.

The modality 2 is an image generating apparatus for radiographing a patient to generate a radiographed image (medical image). As the modality 2, various apparatuses can be cited, such as an X-ray radiographing apparatus, a computed tomography (CT) radiographing apparatus, a magnetic resonance imaging (MRI) radiographing apparatus, and an ultrasonic wave/endoscope radiographing apparatus. A radiographed medical image is transmitted to the NAS 4. Incidentally, the modality 2 can add the information pertaining to a medical image, which information has been obtained at the time of radiographing, to the medical image. As the information pertaining to the medical image, for example, patient information, such as the name and the age of a patient; radiography information, such as a radiography date, a modality name, and radiography conditions; image detail information, such as the bit information of a medical image; and the like, can be cited. These pieces of information may be obtained by being input by a radiographing technician with the modality 2, or may be obtained as the information input from an external device.

The server performs the management of various kinds of data saved in the NAS 4 collectively.

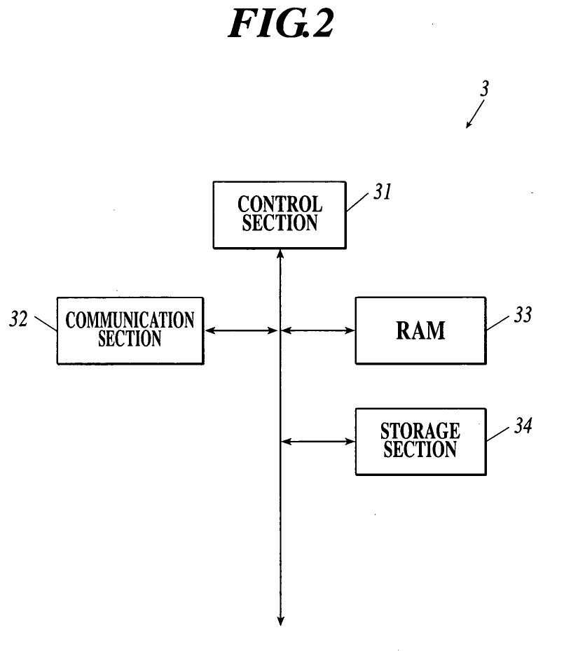

FIG. 2 shows the configuration of the server 3.

The server 3 is composed of a control section 31, a communication section 32, a random access memory (RAM) 33, a storage section 34, and the like, as shown in FIG. 2.

The control section 31 is composed of a central processing unit (CPU) and the like. The control section 31 expands various control programs stored in the storage section 34 in the RAM 33, and performs operations or the centralized control of each of the sections 32-34 in cooperation with these control programs.

The communication section 32 is equipped with a communication interface, such as a network interface card, and performs communication with an external device on the network N. For example, the communication section 32 receives the login information of a user from the medical image display apparatuses 5A and 5B, and transmits the result of the user authentication as a reply.

The RAM 33 is a working memory used by the control section 31.

The storage section 34 stores not only various control programs used in the control section 31, but also the parameters, the data, and the like, which are necessary for the execution of the programs.

For example, the storage section 34 stores a registered user file 341, a display configuration table 342, and a monitor file 343.

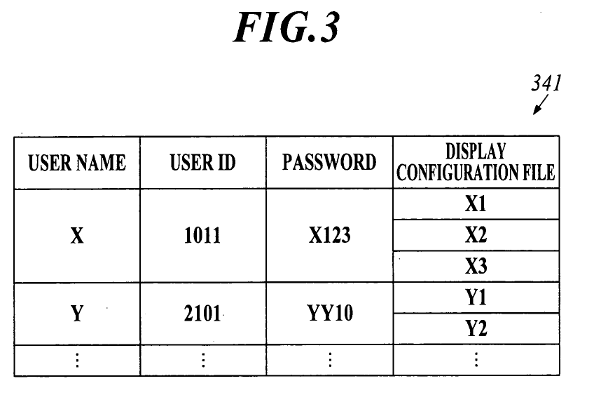

The registered user file 341 is a file to store collating user information for performing user authentication therein. As shown in FIG. 3, the registered user file 341 stores passwords and display configuration file names, both associated with user names and user IDs (numbers given to users in advance for identifying the users individually). A display configuration file is the one for defining the display configurations of the data of various display objects (hereinafter referred to as object data), and the display configuration file is created correspondingly to individual user. Moreover, it is possible to create a plurality of display configuration files to one user by each monitor configuration, or by changing the configuration of display content. Hereupon, the monitor configuration means the number of one or a plurality of monitors provided to each of the medical image display apparatuses 5A and 5B, a combination of various monitors, and the like.

For example, the following is defined: a user “X” has a user ID “1011” and a password “X123”; and the display configuration files corresponding to the user “X” are three files of “X1,” “X2,” and “X3.”

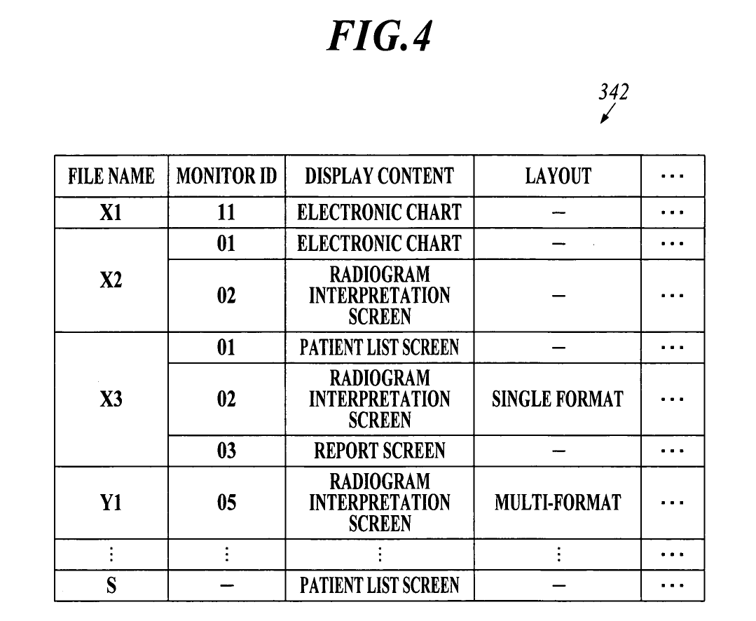

The display configuration table 342 registers the display configuration files of each user. The display configuration table 342 stores each piece of item information of the file names of the display configuration files, the monitor IDs of the monitors to be used for display (which are numbers given to respective monitors in advance for individually identifying the monitors, and which may use MAC addresses and the like), the display content to be displayed on the monitors (kinds of object data), and the layouts of the display content, as shown in FIG. 4. Incidentally, although FIG. 4 lists screen names as the display content, the kinds of object data to be displayed are defined as follows: patient list data on a patient list screen, medical image data on a radiogram interpretation screen, and report data on a report screen.

For example, the display configuration file of the file name “X3” shows the display configuration of three monitors having monitor IDs “01,” “02,” and “03.” Then, it is determined to display a “patient list screen” on the monitor having a monitor ID “01,” a “radiogram interpretation screen” in the layout of a “single format” on the monitor having a monitor ID “02,” and a “report screen” on the monitor having a monitor ID “03.”

Incidentally, the display configuration table 342 registers a basic display configuration file (file name “S”) apart from the display configuration files of each user. The basic display configuration file is previously prepared as a standard display configuration, and the number of the monitors to be used for display is set to one, the minimum number. Moreover, in order to make it possible to apply arbitrary monitors, no monitor ID is especially registered to the basic display configuration file, and a “patient list screen” which is necessary for an initial operation is registered as the display content thereof.

Here, the single format and a multi-format mean the display formats of medical images. The single format is a format for displaying only one medical image in a display region, and the multi-format is a format for displaying a plurality of medical images in divided display regions.

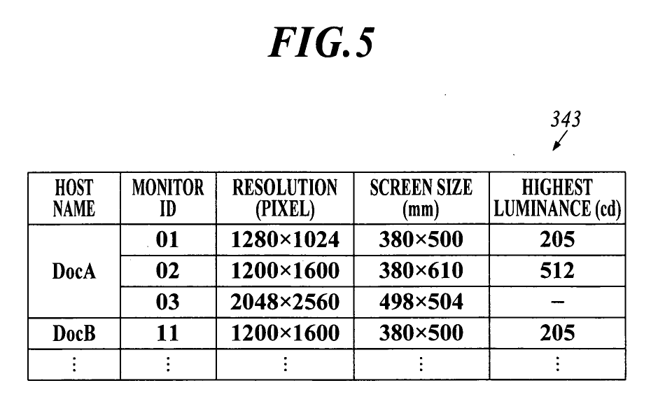

The monitor file 343 is a file for managing the information pertaining to the monitors equipped in all of the medical image display apparatuses 5A and 5B included in the medical image system 1. The monitor file 343 stores the host names of the medical image display apparatuses 5A and 5B, and each item information of the resolution, the screen sizes, and the highest luminance of the monitors equipped in the medical image display apparatuses 5A and 5B with the item information associated with the monitor IDS of the monitors, as shown in FIG. 5.

For example, the following is defined: the medical image display apparatus 5A having a host name “DocA” is equipped with three monitors having the monitor IDS “01,” “02,” and “03,” respectively; and among them the monitor having the monitor ID “01” has the resolution of “1280×1024 (pixels),” the screen size of “380×500” (mm), and the highest luminance of “205” (cd).

The NAS 4 is composed of a large-capacity memory, and stores not only medical images but also various data pertaining to the medical images, such as reports. The NAS 4 outputs instructed data to an instructed external device in conformity with the control of the server 3.

The medical image display apparatuses 5A and 5B are used at the time of the radiogram interpretation of a medical image and a medical operation by a doctor. Each of the medical image display apparatuses 5A and 5B is equipped with one or a plurality of monitors, and displays object data on the monitor.

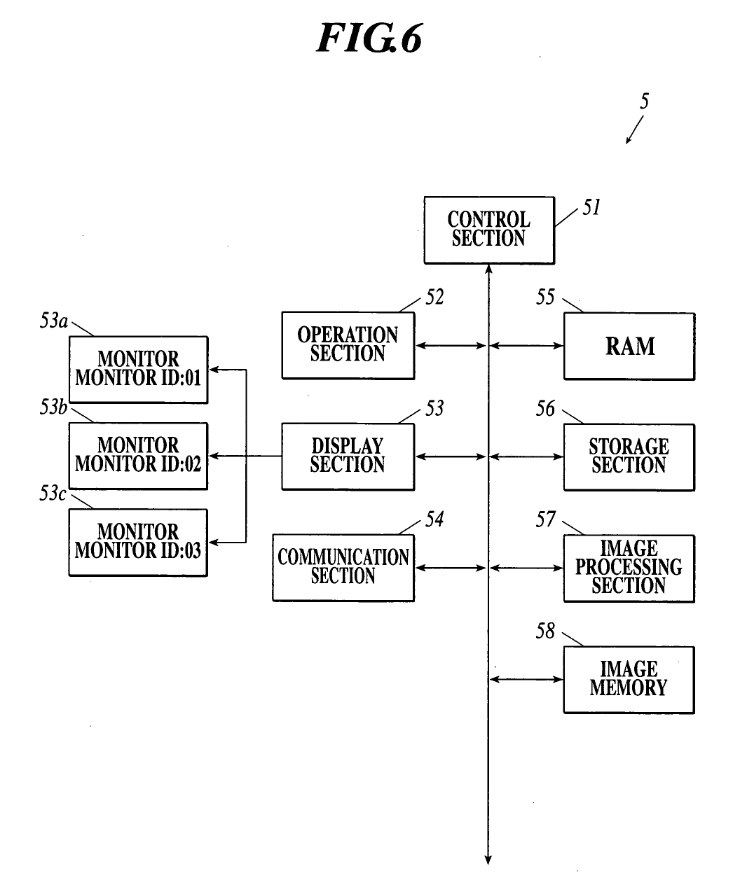

A description is given for the configurations of the medical image display apparatuses 5A and 5B with reference to FIG. 6. But, because the basic configurations of the medical image display apparatuses 5A and 5B are the same, the configuration of the medical image display apparatus 5A is described as a representative.

The medical image display apparatus 5A is composed of a control section 51, an operation section 52, a display section 53, a communication section 54, a RAM 55, a storage section 56, an image processing section 57, and an image memory 58, as shown in FIG. 6.

The control section 51 is composed of a CPU and the like, and reads various control programs stored in the storage section 56 to expand the read control programs in the RAM 55. The control section 51 performs various operations in cooperation with the control programs, and performs the centralized control of each of the sections 52-58.

The operation section 52 is composed of a keyboard, a mouse, and the like. When these ones are operated, the operation section 52 generates the operation signals corresponding to the operations to output the generated operation signals to the control section 51.

The display section 53 is equipped with monitors 53a-53c, and displays a medical image and various kinds of object data of operation screens, such as a report creation screen and an electronic chart screen, on the monitors 53a-53c. As described above, the monitor IDs are individually given to the monitors 53a-53c, and the information of their host names and the monitor IDs is previously registered in the server 3. The registered information is managed in the monitor file 343. Here, the monitor ID of the monitor 53a is supposed to be “01”; the monitor ID of the monitor 53b is supposed to be “02”; and the monitor ID of the monitor 53c is supposed to be “03.”

The communication section 54 is composed of a communication interface, and performs communication with an external device on the network N. For example, the communication section 54 transmits requirement information of requiring object data of a medical image and the like to the server 3, and receives the object data from the NAS 4.

The RAM 55 is a working memory to be used by the control section 51.

The storage section 56 stores not only various control programs to be executed in the control section 51 but also the parameters, the data, and the like, which are necessary for the execution of the programs.

The image processing section 57 performs various kinds of image processing, such as the reduction, the enlargement, the rotation, the inversion, and the like, of object data.

The image memory 58 stores object data.

The film output apparatus 6 outputs a medical image to a film.

Next, the operation of the medical image system 1 is described.

The medical image system 1 enables a doctor to register a display configuration corresponding to a monitor configuration in the server 3 in advance to create a display configuration file, and thereby to use the display configuration file corresponding to the monitor configuration of the medical image display apparatus 5A or 5B to which the doctor has logged in by obtaining the display configuration file from the server 3, regardless of whichever medical image display apparatus 5A or 5B the doctor has logged in.

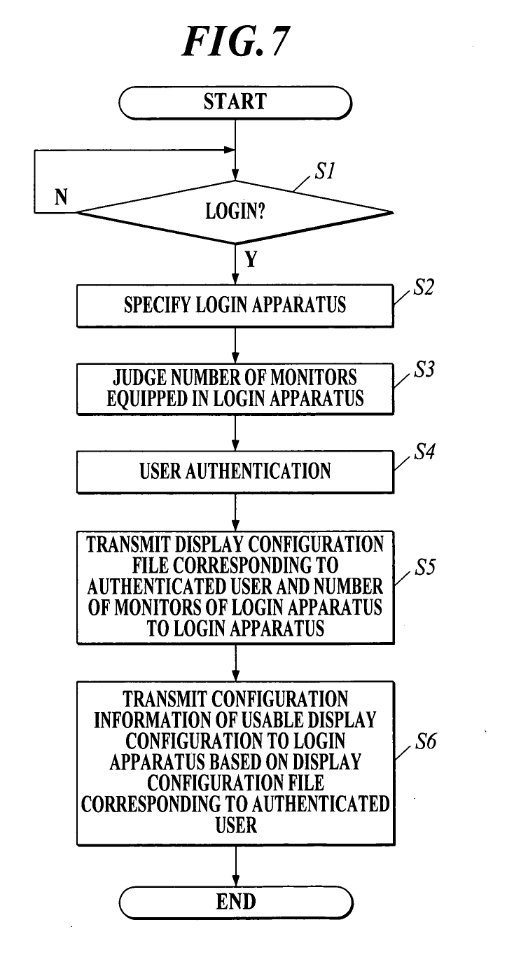

First, a description is given for display configuration file supplying processing, which is executed in the server 3 when a doctor logs in the medical image display apparatus 5A or 5B, with reference to FIG. 7.

In the medical image display apparatus 5A or 5B, when a doctor performs a login operation with the operation section 52, the login information of the user name (or user ID) and the password that have been input by the login operation is transmitted to the server 3. At this time, the information of the host name of the medical image display apparatus 5A or 5B to which the login has been performed is transmitted together with the login information.

In the following, descriptions are given on the supposition that the login operation has been performed in the medical image display apparatus 5A.

In the server 3, as shown in FIG. 7, when the control section 31 judges that the login information from either medical image display apparatus 5A or 5B has been received and a login operation has been performed (Step S1; Y), the control section 31 specifies the medical image display apparatus to which the login has been performed on the basis of the information of the host name received together with the login information (Step S2). To put it concretely, the control section 31 specifies the medical image display apparatus 5A having the same host name in the monitor file 343 as the received one as the login apparatus. In the following, the medical image display apparatus to which the login has been performed will be sometimes called as a login apparatus.

Next, the control section 31 judges the number of the monitors equipped in the specified medical image display apparatus 5A on the basis of the monitor file 343 (Step S3).

When the control section 31 has judged the number of monitors, the control section 31 collates the login information with the registered user file 341 to perform user authentication (Step S4). When no user name and password that accord with the login information are retrieved in the registered user file 341 here, the error information informing the impossibility of the authentication of the user is transmitted to the medical image display apparatus 5A through the communication section 32.

When the user authentication is performed, the control section 31 obtains a display configuration file corresponding to the authenticated user and to the number of monitors of the medical image display apparatus 5A from the registered user file 341 among the display configuration table 342. First, the control section 31 obtains the display configuration file names corresponding to the authenticated user from the registered user file 341, and obtains the display configuration file corresponding to the number of the monitors of the medical image display apparatus 5A among the display configuration files corresponding to the display configuration file names. The control section 31 transmits the obtained display configuration file to the medical image display apparatus 5A, which is the login apparatus (Step S5).

Moreover, the control section 31 generates configuration information indicating the display configurations usable by the authenticated user on the basis of the display configuration files corresponding to the authenticated user, and transmits the generated configuration information to the medical image display apparatus 5A (Step S6). The configuration information includes the information pertaining to the display configurations corresponding to monitor configurations different from the monitor configuration of the medical image display apparatus 5A. For example, in the example shown in FIG. 4, three display configuration files “X1” to “X3” are registered for the user “X,” and their numbers of monitors are “1” to “3,” respectively. Accordingly, the control section 31 determines that a one-monitor display configuration, a two-monitor display configuration, and a three-monitor display configuration are usable, and transmits the configuration information indicating that effect to the medical image display apparatus 5A.

When the control section 31 has transmitted the configuration information, the control section 31 ends the present processing.

When the display configuration files have been transmitted to the medical image display apparatus 5A in this manner, the medical image display apparatus 5A displays object data in conformity with the display configuration files.

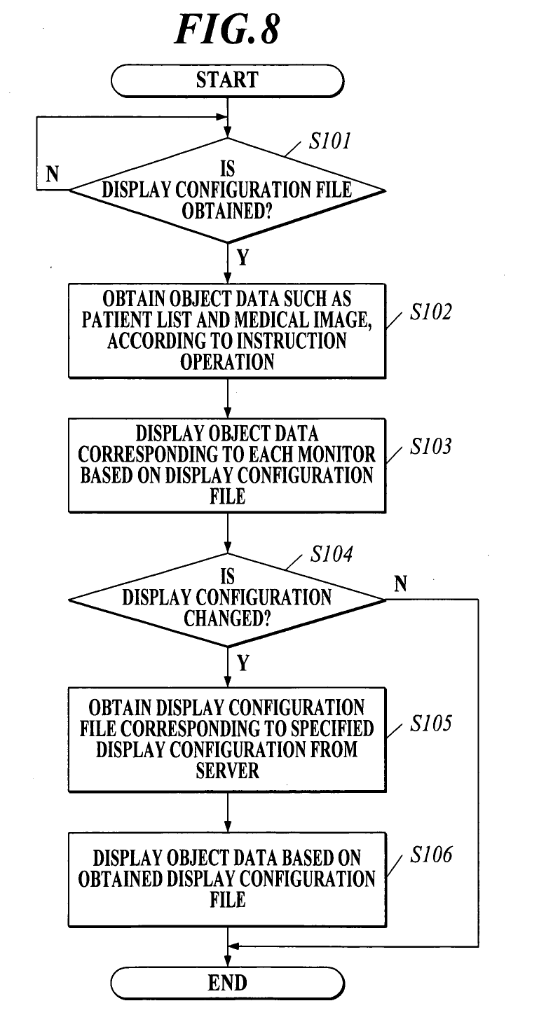

A description is given to the object data displaying processing executed in the medical image display apparatus 5A with reference to FIG. 8. Incidentally, the processing operation of the medical image display apparatus 5A is described here, but the similar processing is also performed in the medical image display apparatus 5B.

As shown in FIG. 8, when the medical image display apparatus 5A obtains the display configuration files from the server 3 (Step S101; Y), the medical image display apparatus 5A saves the display configuration files in the RAM 55. Then, when a doctor performs an instruction operation of object data to be displayed, such as a patient list and a medical image, the medical image display apparatus 5A obtains the object data by the control of the control section 51 (Step S102). At the time of obtainment, the medical image display apparatus 5A transmits the requirement information generated by the control section 51 to the server 3. In the server 3, the NAS 4 is controlled to transfer the object data specified according to the requirement information, and the medical image display apparatus 5A accordingly obtains the object data from the NAS 4.

The control section 51 judges the monitors on which the object data is to be displayed on the basis of the obtained display configuration files, and the control section 51 makes the judged monitors display the object data, respectively (Step S103). When the medical image display apparatus 5A has obtained the display configuration file “X3” shown in FIG. 4, the display configuration file “X3” defines to display a “patient list screen” on the monitor having the monitor ID “01,” a “radiogram interpretation screen” of the single format on the monitor having the monitor ID “02,” and a “report screen” on the monitor having the monitor ID “03.” Because the medical image display apparatus 5A obtains each piece of object data of the patient list from the server 3, and the medical image and the report from the NAS 4, the medical image display apparatus 5A judges that the object data of the patient list is to be displayed on the monitor 53a of the monitor ID “01,” that the object data of the medical image is to be displayed on the monitor 53b of the monitor ID “02” in the single format, and that the object data of the report is to be displayed on the monitor 53c of the monitor ID “03,” and displays each object data on each monitor.

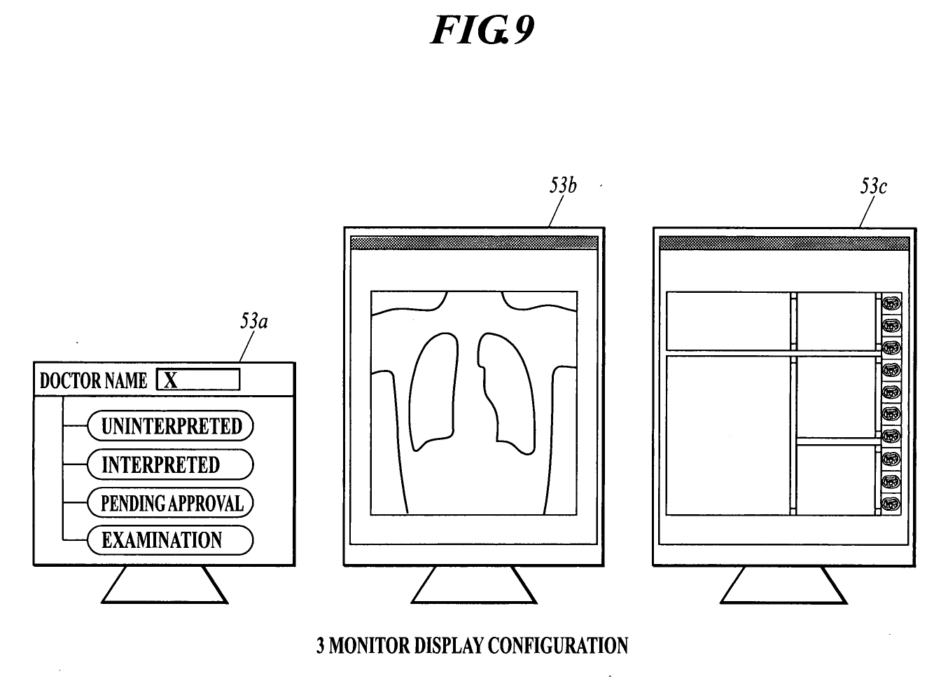

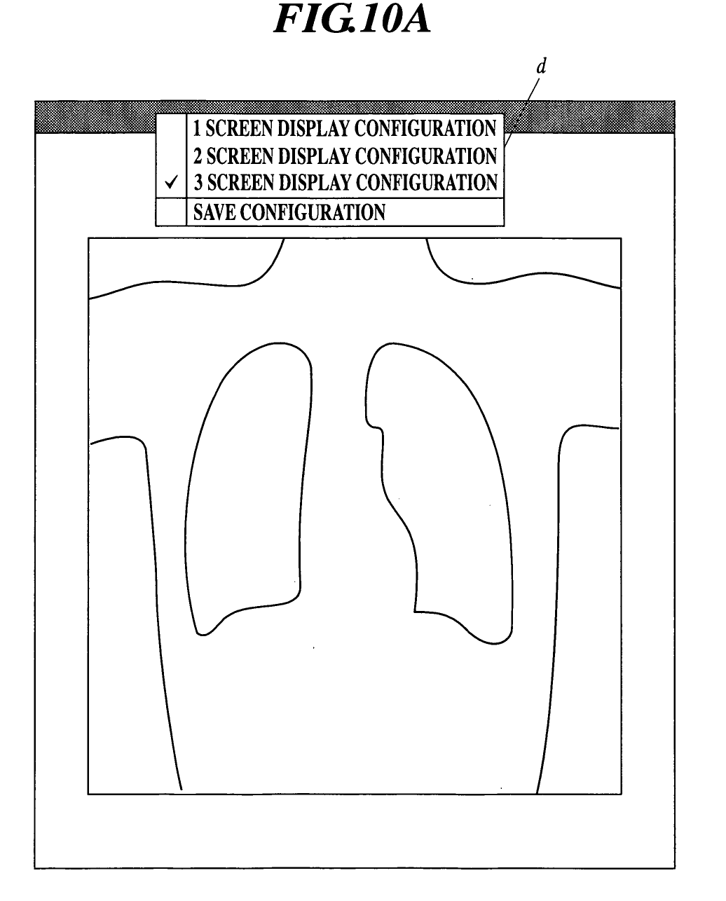

FIG. 9 shows a display example.

As shown in FIG. 9, each object data is displayed in the three-monitor display configuration in accordance with the display configuration file to display the patient list screen on the monitor 53a, the radiogram interpretation screen of the single format on the monitor 53b, and the report screen on the monitor 53c.

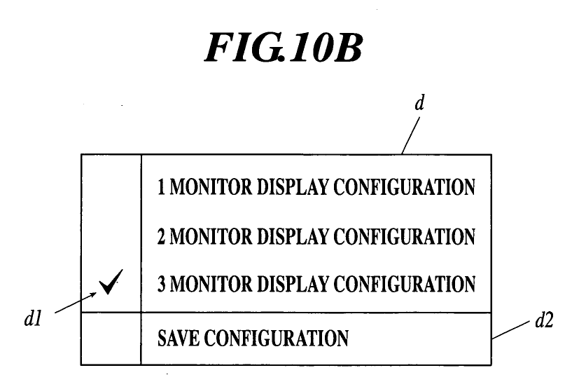

These screens can display an operation menu d for specifying the change of the present display configuration to another display configuration as shown in FIG. 10(a) by the execution of the display control by the control section 51 on the basis of the configuration information transmitted together with the display configuration file. FIG. 10(b) shows the enlarged view of the operation menu d. In the operation menu d, a list of the display configurations which are usable by an authenticated user is displayed. Moreover, a check mark d1 is displayed for the display configuration that is used for the present display of the object data, and the present display configuration is thus made to be capable of being identified by means of the check mark d1. That is, the check mark d1 is the identification information indicating the present display configuration.

An instruction button d2 of configuration saving is displayed on the lower side of the display configurations in the operation menu d. By an operation of the instruction button d2, the presently displayed display configuration can be registered as a display configuration file in the server 3. In the medical image display apparatus 5A, when the instruction button of configuration saving is operated, the control section 51 creates a display configuration file by associating the display content of the present object data with the monitor ID of the monitor displaying the object data. The medical image display apparatus 5A transmits the display configuration file to the server 3 through the communication section 54 together with the host name of the medical image display apparatus 5A and the login information of the user. In the server 3, the display configuration file is newly stored in the display configuration table 342, and the update of the registered user file 341 is performed.

Moreover, when a user wants to change the present display configuration to another display configuration, then the user can change the display configuration by switching the display configuration in the operation menu d. For example, when the user wants to the present three-monitor display configuration (display configuration corresponding to the monitor configuration in which the number of monitors is three) to the two-monitor display configuration (display configuration corresponding to the monitor configuration in which the number of monitors is two), then the user performs the specification operation of the display configuration of “two-monitor display configuration,” which is to be used after the switching, among the display configurations displayed in the operation menu d in a list.

In the medical image display apparatus 5A, when the specification operation of the display configuration to be used after the switching is performed, the medical image display apparatus 5A recognizes the instruction of the change of the display configuration (Step S104; Y), and obtains the specified display configuration file from the server 3 by the control of the control section 51 (Step S105). At the time of the obtainment, the control section 51 first generates the requirement information requiring the display configuration file corresponding to the specified display configuration, and transmits the generated requirement information to the server 3 through the communication section 54. Because the server 3 retrieves the specified display configuration file from the display configuration table 342 to transmit the retrieved display configuration file to the medical image display apparatus 5A in response to the requirement information, the medical image display apparatus 5A is led to obtain the transmitted display configuration file.

Next, the control section 51 performs the switching control of the display configuration, and performs the redisplay of the object data on the basis of the obtained display configuration file (Step S106). Then, the control section 51 ends the present processing. Because the method of displaying the object data based on the display configuration file is the same as the one described above, the description thereof is omitted.

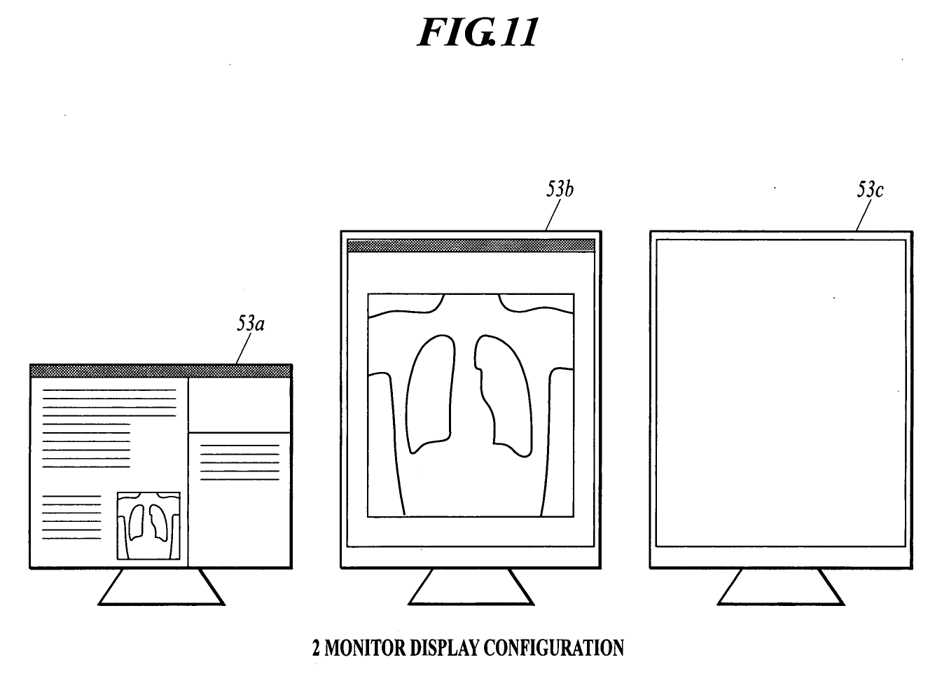

For example, a case is assumed as follows. That is, the two-monitor display configuration is specified in the operation menu d shown in FIG. 10(b) from the state in which the display of object data is performed in the three-monitor display configuration as shown in FIG. 9. In this case, the medical image display apparatus 5A obtains the display configuration file “X2” (see FIG. 4) from the server 3. Then, the medical image display apparatus 5A changes object data and the display configuration so that the “electronic chart screen” is displayed on the monitor 53a of the monitor ID of “01”, and that the “radiogram interpretation screen” is displayed on the monitor 53b of the monitor ID of “02,” as shown in FIG. 11 on the basis of the display configuration file “X2.”

As described above, according to the present embodiment, the server 3 previously creates display configuration files according to the monitor configurations adoptable in the medical image display apparatuses 5A and 5B for each user, and registers the created display configurations. Thereby, the medical image display apparatuses 5A and 5B can obtain the display configuration files according to various monitor configurations, and can perform the display of object data on the basis of the display configuration files.

Consequently, a doctor can freely change the display configuration according to a use in the medical image display apparatus 5A or 5B to which the doctor has once logged in, and the operation efficiency of the user is improved. Moreover, because the display configuration to be used after the switching can be specified from the operation menu d, the display configuration can be changed by an easy operation, and the usability thereof is good.

Moreover, because the display configuration files can be registered for each user, not only the display configuration files can correspond to monitor configurations, but also the display content can be made to be a display configuration according to a doctor by creating the display configuration file based on the display content according to the preference and the style of the doctor.

Moreover, because a display configuration file stores display content on a monitor in association with each monitor ID, it can be determined which object data is displayed on which monitor. Moreover, the layout and the like of display content of a medical image can be also registered, and the detailed customization of a display configuration can be performed.

Incidentally, the embodiment described above is a preferable example to which the present invention is applied, and the present invention is not limited to the embodiment.

For example, display configuration files may be provided for every group of an internal department, a surgery department, and the like. In this case, the display configuration files to be used in each group can be shared, and the work sequences of doctors can be unified.

Moreover, instead of providing display configuration files to each user as in the embodiment described above, display configurations may be registered for each monitor configuration adoptable in each of the medical image display apparatuses 5A and 5B, as the shared display configuration files by each of the medical image display apparatuses 5A and 5B. For example, when the maximum number of monitors in all of the medical image display apparatuses 5A and 5B is three, three display configuration files corresponding to the numbers of monitors of one, two, and three are previously registered. By using these display configuration files, each user can change a display configuration to the one corresponding to all of the monitor configurations.

### INDUSTRIAL APPLICABILITY

The present invention is usable in the field of display techniques, and can be applied to a medical image system in which medical image data and display object data pertaining to a medical image are displayed on a monitor.

1. A medical image system comprising:
a medical image display apparatus comprising one or a plurality of monitors;
a storage section to store display configurations of object data, which correspond to each of monitor configurations adoptable in the medical image display apparatus;
a display control section to display the object data on a monitor of the medical image display apparatus based on a display configuration corresponding to any one monitor configuration among the stored display configurations; and
a switching control section to switch the display configuration corresponding to the one monitor configuration to a display configuration corresponding to another monitor configuration.

2. The medical image system of claim 1, wherein the display control section makes identification information of the display configuration used for displaying the object data be displayed.

3. The medical image system of claim 1, further comprising an operation section to specify a monitor configuration to be used after switching the display configuration, wherein
the switching control section switches to the display configuration corresponding to the monitor configuration specified through the operation section.

4. The medical image system of claim 1, wherein the storage section stores the display configurations corresponding to each of the monitor configurations for each user,
the medical image system further comprises a determining section to determine a user who has logged in the medical image display apparatus for displaying the object data,
the display control section displays the object data on the monitor of the medical image display apparatus, based on the display configuration corresponding to any one monitor configuration, among the display configurations corresponding to the determined user, and
the switching control section switches the display configuration corresponding to the one monitor configuration to the display configuration corresponding to another monitor configuration among the display configurations corresponding to the user.

5. The medical image system of claim 1, wherein the display control section displays identification information which indicates the display configuration of the object data being currently displayed in the monitor of the medical image display apparatus, on the monitor.

6. The medical image system of claim 4, wherein the display control section displays a list of the display configurations corresponding to the user on the monitor of the medical image display apparatus, and
when the one display configuration is specified among the list through the operation section, the display control section switches to the specified display configuration to display the object data.
